(19) United States
(12) Patent Application Publication
(10) Pub. No.: US 2009/0198797 A1
(43) Pub. Date: Aug. 6, 2009

(54) NETWORK DEVICE PROVISIONING USING DOCUMENTS

(75) Inventors: Kuansan Wang, Bellevue, WA (US); Douglas P. Duchene, Redmond, WA (US); Jai Srinivasan, Kirkland, WA (US); Jayman Dalal, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/026,012

(22) Filed: Feb. 5, 2008

(51) Int. Cl. G06F 15/177

(52) U.S. Cl. 709/220

(57) ABSTRACT

Described is a technology by which a network device uses a document to provide its device description information to a network entity upon connection to a network. From the device description information, the device is provisioned, via a provisioning document by which the device configures itself for interaction with the network. In one example, the documents are XML-based documents each referenced via a uniform resource locator. In one implementation, a discovery agent detects a device broadcasting a discovery message on a network. The discovery agent determines whether the device has been previously provisioned on the network, (and is not being re-provisioned). If so, an assigned network server is directed to take over interaction with the device. If not, the discovery agent provides data to a provisioning agent that provisions the device by providing a device provisioning document by which the device configures itself for interaction with the network.

### BACKGROUND

Network devices such as VoIP (voice over Internet Protocol) telephones are difficult to setup, configure and maintain. Automatic “plug-and-play” type solutions have been attempted, but these solutions only work to a limited extent.

Part of the problem is the relatively large number of variations that are possible. To automatically configure such devices from a network server requires maintaining a substantial database, as well as the use of an identification (e.g., numbering) system that identifies the various device types, properties, features, configuration settings and so forth so that the server can match a type of device to its appropriate settings.

Although to an extent it is possible to design such an identification system and build and distribute such a database, the maintenance of such a database is very difficult. For example, any time a device vendor puts out a new device, new property and/or new feature, a new number is required, and the database needs to be updated with new information to support the device and/or feature. Such a database solution does not scale well and is not practical to maintain.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a network device uses a (e.g., structured XML) document to provide its device description information to a network entity upon connection to the network. From the device description information, a network entity provisions the device, e.g., by returning a (e.g., structured XML) provisioning document. The device uses the provisioning document to configure itself for interaction with the network.

In one aspect, a device that is coupled to a network is detected (e.g., by a device-provided broadcast message), and a description document corresponding to the device including information that describes the device is obtained. For a newly discovered device, or for a device being re-provisioned, a provisioning document based on the information included in the description document, including at least some of any device-independent information, is provided, the provisioning document containing device configuration information by which the device may configure itself for network operation. For example, the documents may be XML-based documents each referenced via a uniform resource locator.

In one aspect, a discovery agent or the like detects a device coupled to a network, and determines whether the device has been previously provisioned (and is not being re-provisioned) on the network. If so, the discovery agent communicates with a network server that is configured to interact with the device, whereby the device may resume interaction. If the device was not previously provisioned or is being re-provisioned, the discovery agent provides data that corresponds to a device description document to a provisioning agent or the like. The provisioning agent provisions the device for interaction with the network, such as by assembling a device provisioning document by which the device may configure itself.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1A is a block diagram representing example components of a network and example data communication therein for discovering and provisioning network devices.

FIG. 1B is an alternative block diagram representing example components of a network and example data communication therein for discovering and provisioning network devices

FIG. 2 is a flow diagram representing example steps taken in discovering and provisioning a network device.

FIG. 3 is a flow diagram representing example steps taken by a network device to facilitate discovery and provisioning.

FIG. 4 shows an illustrative example of a computing and networking environment into which various aspects of the present invention may be incorporated

### DETAILED DESCRIPTION

Various aspects of the technology described herein are generally directed towards provisioning a network device in a generally device-independent manner, through the use of documents such as structured XML-based documents. For example, an XML document may be used by a network device to describe itself to a network entity, and in return the network device receives another XML document directed towards provisioning the network device, by which the network device configures itself for operation in the network.

While some of the examples herein are directed towards XML structured documents and a network device in the form of a VoIP telephone, it will be understood that virtually any type of document may be used, and that any network device may benefit from the technology described herein. Further, while examples are described via the use of DHCP (Dynamic Host Configuration Protocol) and HTTP (HyperText Transfer Protocol), other protocols may be used. Still further, it will be understood that the technology described herein applies to other scenarios, including where multiple devices discover and exchange settings and other data between one another.

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and networking in general.

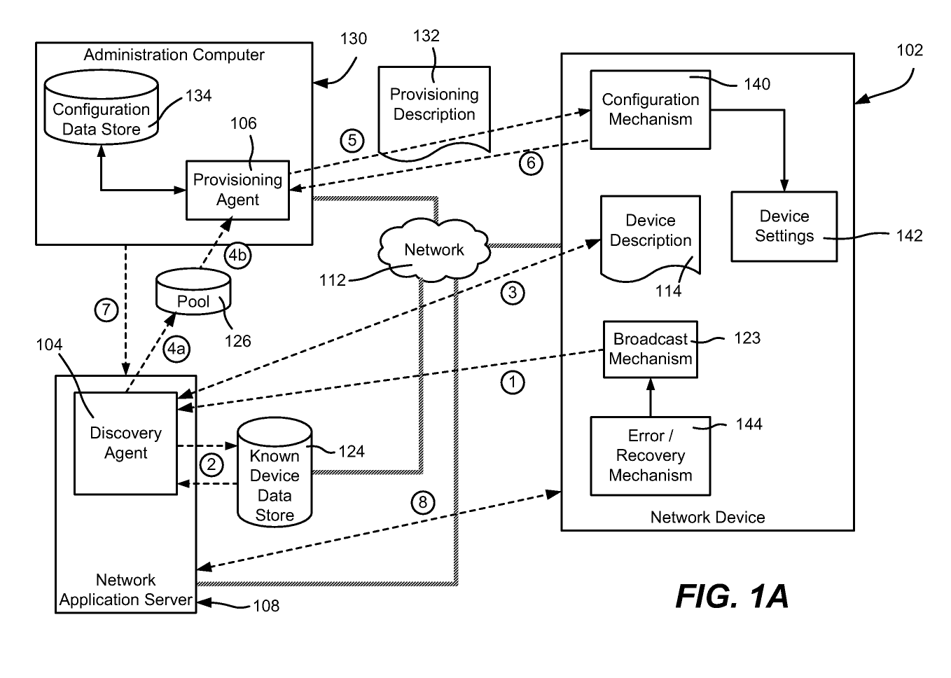

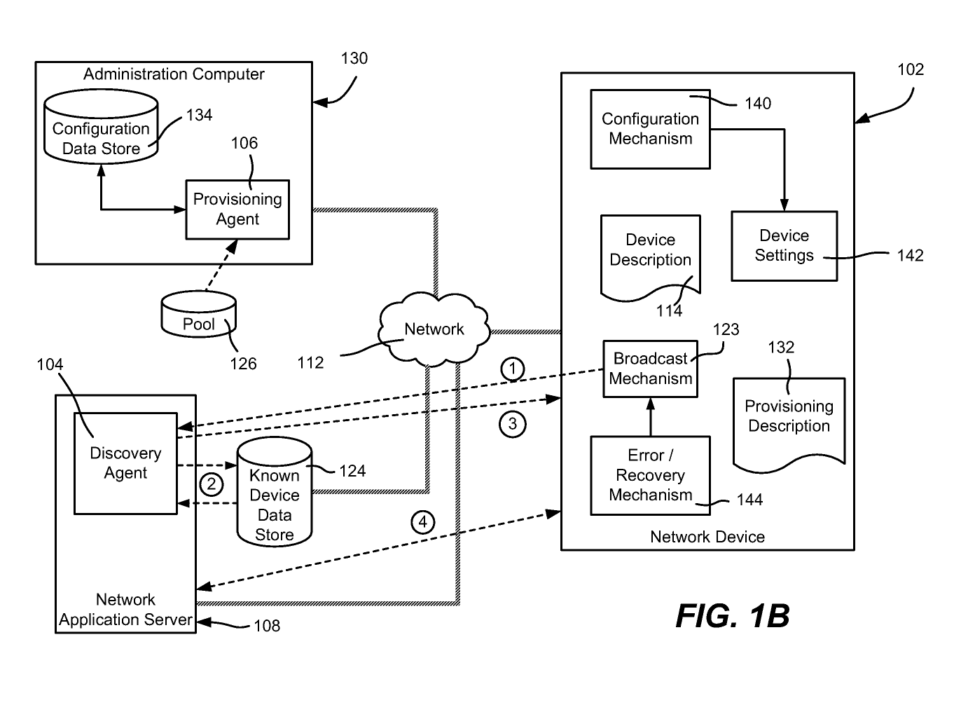

Turning to FIG. 1A, one example implementation includes various logical entities for discovering and provisioning a network device 102 (e.g., a communication terminal such as a VoIP phone), including a discovery agent 104, a provisioning agent 106 and a network application server 108 (e.g. a server that facilitates connections to communication terminals such as a VoIP registrar and/or proxy server). These logical components can reside in physical entities distributed across a network 112, or may be combined into one or more physical computer systems; note that the logical components represented in the figures are only examples, and may be restructured, further combined, and/or further separated into additional components. For example, as represented in FIG. 1A, the discovery agent 104 is shown as being incorporated into the network application server 108. Many such discovery agents and/or application servers may be present in a given network.

With respect to discovery, the exemplified discovery protocol is based on the network device 102 broadcasting its presence over the local area network (LAN), such as described in published United States Patent Application No. 20070250605, assigned to the assignee of the present invention. For example, although numerous suitable options exist, DHCP may be used to provide the host for the discovery protocol. More particularly, in the example of DHCP, the INFORM method of DHCP is used by the device 102 to announce its presence to the network.

In this DHCP-based example, compliant devices include (option 60), in sequence, a sixteen byte globally unique identifier (GUID) that describes the discovery protocol version and a UTF-8 encoded string representing an abridged Uniform Resource Indicator (URI). As described below, the URI provides the network resources with access to the device's description, e.g., in an XML document 114 (alternatively referred to as a device description language, or DDL document) describing the capabilities of the device, which may include or wholly contain device-independent information. Compliance devices also follow the DHCP INFORM standard. For a VoIP telephone, for example, the device includes an option (option 122) directed towards requesting a SIP-based VoIP server and (option 43) a parameter request list.

As represented in FIG. 1A by the dashed arrow labeled with circled numeral one (1), the discovery agent 104 receives the discovery broadcast from a broadcast mechanism 123 or the like of the network device 102. In one example implementation, the discovery agent 104 inspects the broadcast message to determine whether it is properly formatted, (e.g., with a GUID matching the protocol version). An appropriate error may be returned if the format is not proper.

If the message is properly formatted, the discovery agent 104 evaluates whether the device 102 is already a recognized and provisioned device, e.g., by the network application server 108. In one example implementation, the determination is made by accessing a data store 124 (e.g., performing a table lookup) that is shared between the discovery agent 104 and the application server 108, as represented in FIG. 1A by the dashed arrows labeled with circled numeral two (2). If the device is listed as an entity in the data store 124, the discovery agent proceeds as described below with reference to FIG. 1B in one typical situation; however, in one alternative, a device may be re-provisioned, in which event the device will generally be provisioned as described with respect to FIG. 1A.

More particularly, a device may be need to be re-provisioned. By way of example, consider VoIP telephones that are provisioned with a list of users (commonly as extension numbers). If a phone that has been provisioned for use by a user1 at one extension (e.g., ×100) is assigned to another user2 at another extension (e.g., ×200), the telephone needs to be reconfigured to receive and place calls as user2, which is accomplished by re-provisioning the telephone.

A device may be re-provisioned in a number of alternative ways. For example, the provisioning agent 106 may select to re-provision devices identified in the data store 104, e.g., when the provisioning agent 106 is directed to re-provision certain devices by a human administrator, such as interactively or automatically in a batch job. A re-provisioned device may be instructed to reconfigure itself. In one alternative, the data store 124 may be modified with respect to a re-provisioned device, such as by removing the device entry from the data store, or flagging it in some way as needing re-provisioning; with such alternatives, upon a restart or other condition that generates a discovery broadcast message, the device may be then treated as a new device not already known to the system as being provisioned. Alternatively, the discovery broadcast message sent by the device may indicate that the device is to be re-provisioned; such a message may be sent when the firmware on a device is changed to a different version, and/or when the device description list changes its URI. The discovery agent 104 may handle such a re-provisioning discovery message differently, e.g., by bypassing the data store access (except to possibly update the data store 124) and treating the device as a new, unknown device.

Initially, a new device will not be listed in the data store 124, (or listed as needing re-provisioning or known via its broadcast message to be treated as a new device), whereby it needs to be provisioned. More particularly, if the device is considered new for initial provisioning or re-provisioning, the discovery agent 104 obtains a most recent copy of the device description language document 114 from the device 102 based on the URI provided in the broadcast message. In FIG. 1A, this is represented by the dashed arrow labeled three (3). Note that in an alternative, the device need not contain the device description document, but instead may provide a reference to such a document maintained at a different location (e.g., on another device, at a network storage site, at an internet site, and so forth).

In one implementation, the device description language document 114, together with the time stamp of the broadcast and other network specific information of the device (e.g. MAC address), are logged into a pool 126 or the like of newly discovered devices to be consumed by the provisioning agent 106; other discovery agents, if any, may also log newly discovered device data into the pool. Alternatively, the provisioning agent may query the discovery agent (as well as any other discovery agents) for information about newly discovered devices; indeed, any communications described herein can be push or pull-based operations. In FIG. 1A, the dashed arrows labeled (4a) and (4b) represent the logging and consumption, respectively, and although “plug-and-play” like operation is desirable, it can be readily appreciated that consumption need not take place on demand, but may be deferred. Note that it is equivalent to alternatively have the discovery agent 14 provide the provisioning agent 106 with the URI rather than the device description document 114 itself, whereby the provisioning agent 106 can retrieve the document 114 when needed, and indeed if provisioning is deferred may provide the provisioning agent 106 with a more up-to-date copy.

Note that in one example implementation, an abridged URI is used; for example, a URI is a URL (uniform resource locator) typically in the following format:
<protocol>:<server address>[:port number]/<resource path><resource name>
   However, for security reasons, in a LAN environment the server address may be omitted in the discovery protocol. The discovery agent 104 automatically fills in the network address used in the broadcast message so as to ensure the device description language document 114 is indeed fetched through the device that is announcing its presence.

Further, the resource name is tied to the versioning of the device capability. As a result, the discovery agent 104 may determine whether a device's properties have changed by analyzing the name of the device description language document 114.

With respect to provisioning, under a usage scenario of interactive provisioning, the provisioning agent 106 may be automated, or may be semi-automated, such as to guide a human administrator to enter configuration data through an appropriate user interface. For example, the provisioning agent may prompt the administrator to enter the desired parameters in a step-by-step manner. As represented in FIG. 1, the provisioning agent 106 is incorporated into an administrator computer 130 that facilitates such operations. The configuration data is based on the discovered device in the pool entry provided by the discovery agent along with the corresponding properties described in the device description language document 114 for that device. By way of example, for a VoIP application, the configuration data may include the phone number, the account number, the username/password, and so forth.

Moreover, the device description language document 114 may be used to help with the physical setup of a device. By way of example, one problem with configuring devices is that the user interface that accepts administrator (or user) input to configure the devices heretofore had no information regarding such physical aspects, such as the device packaging, the connectors that need to be attached to the device, and/or the labels of the connector jacks. As a result, it is often difficult for the administrator (or user) to correlate the values of configuration data to enter into the user interface with the physical setup of the device.

With a device description language document 114, manufacturers of devices may include the labels of connectors on the device, whereby the user interface may display these labels, for example. As a more particular example, a telephone may be configured to receive and place calls for multiple users, such as by having each user's calls directed to that user via a specific extension, with lights or the like to show to which user an incoming call is directed. The telephone may also provide one or more buttons or the like that allow a user to make calls as a specific person or group (e.g., as a Sales user). Labels for such lights and buttons may be included in the device description language document 114 so as to be visible when configuring the telephone, which allows the administrator (or user) to easily understand how the configuration data being entered relates to the telephone. As can be readily appreciated, this may be extended (e.g., by standardized XML) to other aspects of device configuration, maintenance and/or management, such as to provide text, graphics and/or video for troubleshooting devices and so forth, which are provided by the device description language document 114 and tailored to the device model.

Once the configuration data are collected, the provisioning agent 106 assembles the data into a (e.g., structured XML-formatted) document that may contain device-independent information, referred to herein as a provisioning description language (PDL) document 132, and sends the document 132 to the device 102. Note that while in this example the provisioning agent pushes the provisioning description document 132 to the device, the document 132 may be pulled via a query. In another alternative, a server may be assigned to provide the document via a push mechanism or pull-based mechanism (e.g., the provisioning agent provides a server address to the device for downloading the document). In general, such provisioning occurs when a device is plugged into the network and discovered.

In one alternative, a second usage scenario provides for “batch” provisioning, in which an administrator or service can enter some or all of the configuration data into a configuration data store 134 before such a device is connected to the network. This can be facilitated through an administrator user interface, and/or by downloading relevant data, such as from a directory service e.g., Active Directory® in Windows® Server. As one or more devices are connected to the network and are discovered, the provisioning agent 106 extracts the configuration data from the configuration data store 134 to dynamically assemble and send the provisioning description language document 132 to each device.

In general, a configuration mechanism 140 of the device 102 receives the provisioning description language document 132, (the dashed arrow labeled five (5)) from which it will configure the device settings 142 accordingly. In one example implementation, the provisioning description language document 132 is received using the same URI as the device description language document 114, with the exception that the resource name has a “.PDL” extension (rather than a “.DDL” extension). One mechanism suitable for fetching the device description language document 114 and sending the provisioning description language document is HTTP, although other protocols are also applicable.

Upon receiving a provisioning description language document 132, the device's configuration mechanism 140 checks the syntax and the version of the document 132, and the intended device address specified in the provisioning description language document. The device returns a positive acknowledgment (the dashed arrow labeled six (6)) if the items are correct and acceptable, or with a corresponding error code otherwise. In one example, the acknowledgement transmission usually occurs before any data changes are applied and completed by the device.

Note that in one example protocol, the device may be required to make its existing configuration data available in the same manner as the device description language document 114. One example implementation specifies that the device is to report the configuration data that is currently in use, rather than the data to be applied; (the device ignores the request and let it time out if the device is busy). Thereafter the provisioning agent 106, for example, may fetch the provisioning description language document 132 from the device 102 to see if the device is busy, and if not, to determine whether certain changes have been applied and taken effect.

Once the device 102 is appropriately configured, interactivity with the server application 108 may occur, including for example communicating heartbeat signals. In a networking environment, where multiple such servers are present, a newly discovered device may be assigned to any server, (such as for load balancing, to match a device to a department, and/or the like), or may be assigned based on which discovery agent discovered it, e.g., the server into which a discovery agent is incorporated.

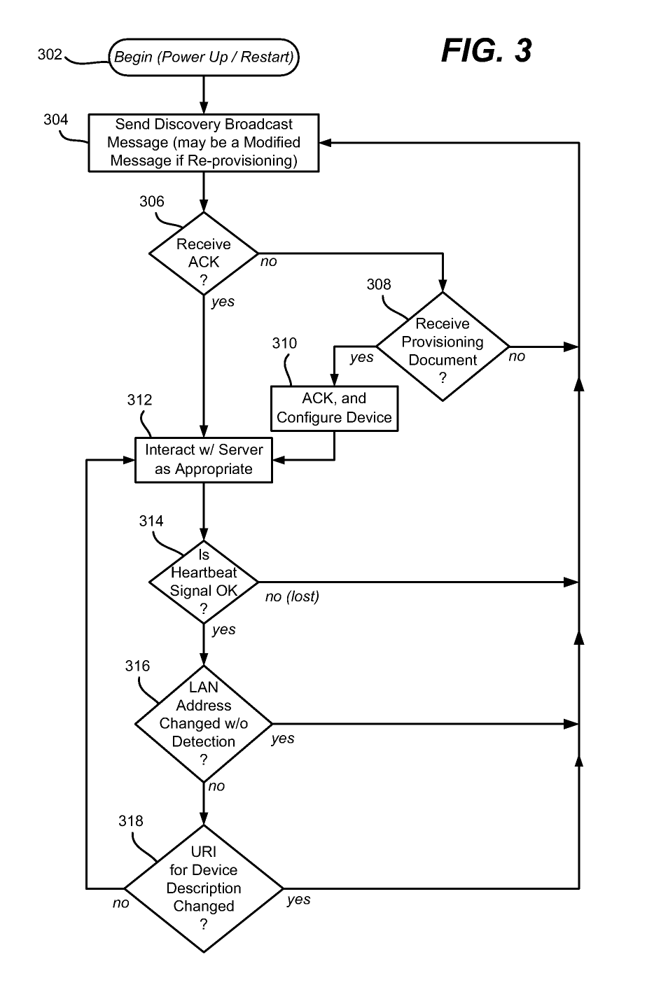

The interactivity continues indefinitely, unless a network state change such as an error or other error-like event (e.g., intentional restart) occurs that necessitates recovery. An error/recovery mechanism 144 is provided to handle such events, as generally described below with reference to FIG. 3.

Turning to FIG. 1 B, as mentioned above, a device that broadcasts its discovery message may already be listed in the data store 124, such as if restarted or another change occurs as exemplified in FIG. 3, described below. In such an event, the device 102 is already recognized as a provisioned device.

For already recognized devices, instead of working with the provisioning agent 106, the discovery agents 104 sends a DHCP acknowledge (ACK) message (in response to the DHCP INFORM broadcast) that includes the GUID reaffirming the protocol version, and the information needed by the device to function with the network server 108, e.g., an address of record for registering with the server, e.g., for management thereby. With this information, the device 102 may directly proceed to interact with the application server 108, for example, by starting a heartbeat signal.

Note that multiple such application servers and/or discovery agents may exist on a given network, and an already-provisioned network device may be managed by a specific application server that is different from the discovery agent's server (if incorporated into a server) that responded to the broadcast message. In the event a different server is already associated with to a device, e.g., as identified in the data store 124, the discovery agent that handled the broadcast message can communicate with that server, which may then take control and restore interactivity with the network device 102.

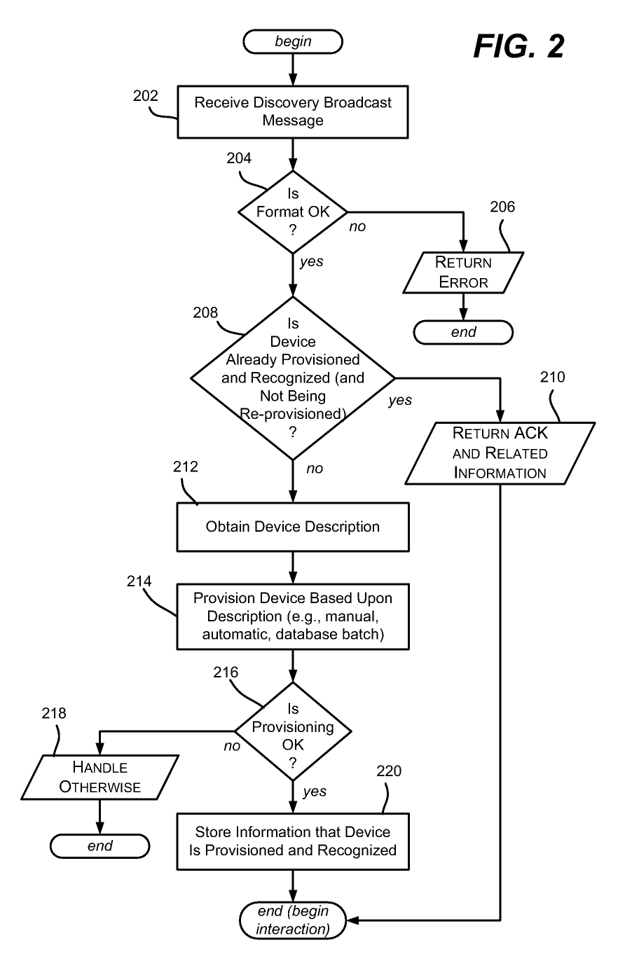

By way of summary, FIG. 2 is a flow diagram representing example steps taken for handling discovery, and if necessary, to provision a device. Note that the steps of FIG. 2 are only examples of a simplified process; for example, the discovery agent and other components in the system are not limited to serially working with discovered devices. Instead, multiple devices may be discovered, including simultaneously or near-simultaneously, and each device may be at a different stage of processing with respect to provisioning, re-provisioning or resuming interaction. For example, between steps 212 and 214, one or more other devices may broadcast discovery messages and may be processed.

Step 202 represents receiving the discovery broadcast message, and step 204 represents evaluating the format of the message. If improper, step 204 branches to step 206 to return an appropriate error.

If the format is proper, step 208 is executed, which represents looking up in the known device data store 124 whether the device is already known and provisioned, (and in one alternative is not directed towards re-provisioning the device). If so, step 210 represents returning an ACK along with the related information whereby the device may interact with the server.

If the device is not recognized (or alternatively is being re-provisioned), step 212 is executed to obtain the device description document from the device. Step 214 represents assembling the provisioning description document and providing the document to the device. As described above, the assembly operation may be manual, automatic, part of a batch operation, or any combination thereof.

Step 216 represents receiving a message (an acknowledgement) that the provisioning document was acceptably received at the device. If not, step 216 branches to step 218 which represents handling the problem in some appropriate way, e.g., attempting a re-send some number of times, notifying an administrator of a problem, and so forth.

In typical operation the provisioning document will be properly formatted and successfully received, whereby step 220 is executed to store information in the data store 124 to indicate that the device is provisioned and recognized. As soon as the device configures its settings based on the provisioning description document, interaction with the network via its application server may begin.

FIG. 3 is a flow diagram representing example steps that may be taken by a device with respect to discovery and provisioning at various times. In general, occasions when the device attempts discovery include when the device is first powered up or just restarted, when the heartbeat signal with the server has been lost, if the LAN address of the device is changed, and such an address change cannot be detected by the server through the heartbeat, and when the URI for device description language document 114 is changed. These four conditions ensure that a discovery agent can detect the presence of the device. Note that for a new device, the discovery attempts are repeated regularly until provisioned.

Step 302 of FIG. 3 represents an initial device power up/restart operation. Step 304 sends a discovery broadcast message to the network, assuming the device is coupled (by a wired or wireless connection) to a network; (the broadcast message can be deferred until connection to a network is detected). Note that as described above, one alternative is to send a modified message if the device was previously known but is now re-provisioning.

Step 306 represents testing for receipt of an acknowledgement indicating that the device is already known to the network; note that an acknowledgement is not received (or a different communication is received) when re-provisioning. If such an acknowledgement is not received, step 308 is executed to evaluate whether a provisioning document is instead received; if so, at step 310 the device acknowledges receipt and configures its settings. Some delay may be present to give the network time to acknowledge or provide a provisioning document, e.g., an exponential back-off mechanism may be used. Note that in this simplified example, error handling with respect to the broadcast message and/or the document is not depicted, and thus in this example either an “already-known” acknowledgment or a properly formatted provisioning document is eventually received, with repeated broadcast messages sent (possibly after some delay) by looping back to step 304 until one or the other is received.

If the acknowledgement for already known (and not being re-provisioned) was received at step 306, or following configuration at step 310, the device is able to interact with the server as needed. For example, in addition to functional data (e.g., VoIP-related data) being communicated, regular heartbeat signals may be exchanged to ensure uninterrupted coupling.

Steps 314, 316 and 318 represent operations by the error/recovery mechanism 144 related to re-sending the broadcast message if necessary. Step 314 represents detecting when the heartbeat signal with the server has been lost, resulting in the discovery broadcast message being re-sent. Step 314 represents detecting if the LAN address of the device is changed, and such an address change cannot be detected by the server through the heartbeat; if so the broadcast message is re-sent by returning to step 304. Step 314 represents detecting when the URI for the device description language document 114 has changed, whereby the broadcast message is re-sent by returning to step 304. Note that while steps 314, 316 and 318 are represented in FIG. 3 as part of a loop, it is understood that any or all of these operations may be event-triggered rather than repeatedly evaluated for a state change.

As can be readily appreciated, other aspects of the technology herein include that the network may be the Internet rather than a LAN. In this manner, for example, a home user can plug a device such as a VoIP phone or a printer into a gateway, switch or router (directly or via a computer) whereby it can be automatically configured by a service provider or the like.

Another aspect is that the device user can edit certain user-configurable settings, which then may be used as some of the data in the device description language document. In this manner, a user may customize a device to some extent, possibly subject to administrator policy. For example, a user may customize various ring tones for a VoIP phone device.

Yet another aspect is that the network server need not support every property of the device. Instead, because in one implementation a structured (extensible XML) document is used for the description, the device may specify in the document that a device-dependent handler be invoked when needed, such as provided by the device manufacturer or a third party, for use with that property (or a set of properties).

### EXAMPLE TELEPHONE-RELATED XML SCHEMA FOR THE DDL

```
<?xml version=“1.0” encoding=“utf-8”?>
<xs:schema attributeFormDefault=“unqualified” elementFormDefault=“qualified”
targetNamespace=“http://schemas.microsoft.com/Edinburgh/DevicesDescription/
1.0” xmlns:xs=“http://www.w3.org/2001/XMLSchema”>
  <xs:element name=“ddl”>
    <xs:complexType>
      <xs:sequence>
        <xs:element name=“manufacturer”>
<xs:simpleType>
<xs:restriction base=“xs:string”>
              <xs:maxLength value=“32”/>
            </xs:restriction>
</xs:simpleType>
</xs:element>
        <xs:element name=“model” >
<xs:simpleType>
<xs:restriction base=“xs:string”>
          <xs:maxLength value=“32”/>
</xs:restriction>
</xs:simpleType>
</xs:element>
        <xs:element name=“version”>
<xs:simpleType>
<xs:restriction base=“xs:string”>
            <xs:maxLength value=“32”/>
</xs:restriction>
</xs:simpleType>
</xs:element>
        <xs:element name=“provisionable” type=“xs:boolean” />
        <xs:element name=“devices”>
          <xs:complexType>
            <xs:sequence>
            <xs:element minOccurs=“0” maxOccurs=“unbounded” name=“line”>
              <xs:complexType>
                <xs:sequence>
                  <xs:element name=“outboundDialingMethod” type=“xs:unsignedByte” />
                </xs:sequence>
                  <xs:attribute name=“id” type=“xs:string” use=“required” />
                  <xs:attribute name=“display” use=“required”>
  <xs:simpleType>
<xs:restriction base=“xs:string”>
<xs:maxLength value=“16”/>
</xs:restriction>
  </xs:simpleType>
  </xs:attribute>
                </xs:complexType>
              </xs:element>
              <xs:element minOccurs=“0” maxOccurs=“unbounded” name=“phone”>
                <xs:complexType>
                  <xs:attribute name=“id” type=“xs:string” use=“required” />
                  <xs:attribute name=“display” use=“required”>
  <xs:simpleType>
<xs:restriction base=“xs:string”>
<xs:maxLength value=“16”/>
</xs:restriction>
  </xs:simpleType>
  </xs:attribute>
                </xs:complexType>
              </xs:element>
            </xs:sequence>
          </xs:complexType>
        </xs:element>
      </xs:sequence>
    </xs:complexType>
  </xs:element>
</xs:schema>
```

### EXAMPLE TELEPHONE-RELATED XML SCHEMA FOR THE PDL

```
<?xml version=“1.0” encoding=“utf-8”?>
<xs:schema attributeFormDefault=“unqualified” elementFormDefault=“qualified”
targetNamespace=“http://schemas.microsoft.com/Edinburgh/ProvisionData/1.0”
xmlns:xs=“http://www.w3.org/2001/XMLSchema”>
  <xs:element name=“pdl”>
    <xs:complexType>
      <xs:sequence>
        <xs:element name=“deviceAddress” type=“xs:string” />
        <xs:element name=“sipServer” type=“xs:string” />
        <xs:element name=“voiceMailManagerURI” type=“xs:string” />
        <xs:element name=“autoAttendantURI” type=“xs:string” />
        <xs:element name=“parkPlaceURI” type=“xs:string” />
        <xs:element name=”autoAnswerURI” type=”xs:string” />
        <xs:element name=”publicAddressURI” type=”xs:string”/>
        <xs:element name=“userAgents”>
          <xs:complexType>
            <xs:sequence>
              <xs:element name=“line” minOccurs=“0” maxOccurs=“unbounded”>
                <xs:complexType>
                  <xs:sequence>
                    <xs:element name=“aor” type=“xs:string” minOccurs=“1” />
                    <xs:element name=“userName” minOccurs=“0” />
                    <xs:element name=“password” minOccurs=“0” />
                    <xs:element name=“authentication” minOccurs=“0” />
                  </xs:sequence>
                  <xs:attribute name=“id” type=“xs:string” use=“required” />
                </xs:complexType>
                </xs:element>
                <xs:element name=“phone” minOccurs=“0” maxOccurs=“unbounded”>
                  <xs:complexType>
                    <xs:sequence>
                      <xs:element name=“aor” type=“xs:string” minOccurs=“1” />
                      <xs:element name=“display” type=“xs:string” minOccurs=“0” />
                      <xs:element name=“userName” minOccurs=“0” />
                      <xs:element name=“password” minOccurs=“0” />
                      <xs:element name=“authentication” minOccurs=“0” />
                    </xs:sequence>
                    <xs:attribute name=“id” type=“xs:string” use=“required” />
                  </xs:complexType>
                </xs:element>
              </xs:sequence>
            </xs:complexType>
          </xs:element>
        </xs:sequence>
      </xs:complexType>
    </xs:element>
  </xs:schema>
```

### EXEMPLARY OPERATING ENVIRONMENT

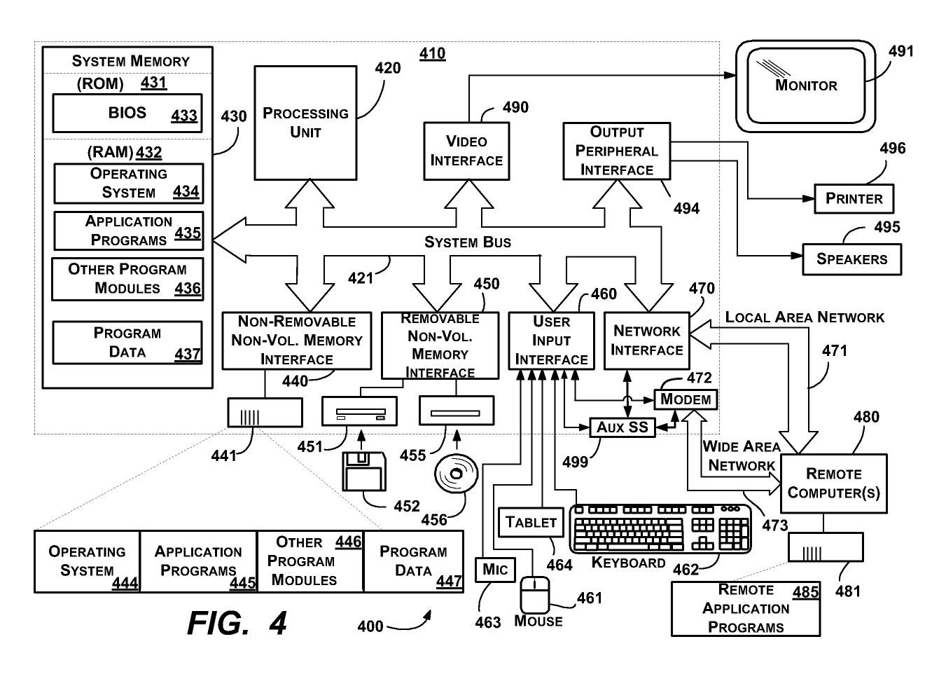

FIG. 4 illustrates an example of a suitable computing and networking environment 400 on which the examples of FIGS. 1A-3 may be implemented. For example, the application server 108 and/or the administration computer 130 may be implemented in the computer system 410, while the device 102 may be represented by the remote computer 480. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component 474 such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computer networking environment, a method comprising:
detecting a device that is coupled to a network;
obtaining a description document corresponding to the device, the description document including information that describes the device; and
providing a provisioning document based on the information included in the description document, including based on at least some of any device-independent information, the provisioning document containing device configuration information by which the device may configure itself for operation with at least one other network entity.

2. The method of claim 1 wherein obtaining the description document comprises retrieving the description document based on a uniform resource locator provided by the device.

3. The method of claim 1 wherein providing the provisioning document comprises assembling the provisioning document and transferring the provisioning document based on a uniform resource locator provided by the device.

4. The method of claim 1 wherein providing the provisioning document comprises transferring a provisioning document to the device.

5. The method of claim 1 further comprising, retrieving the provisioning document previously transferred to the device.

6. The method of claim 1 wherein detecting a device that is coupled to a network comprises receiving a broadcast message from the device.

7. The method of claim 1 wherein providing the provisioning document comprises accessing a configuration data store based on at least some of the information included in the description document to assemble at least some of the provisioning document.

8. The method of claim 1 further comprising, detecting an acknowledgement that the device received the provisioning document, maintaining information that the device is known and provisioned with respect to the network, and further interacting with the device via a network entity.

9. The method of claim 1 further comprising, registering the device for management by a particular server on the network.

10. In a computer networking environment having a network device coupled thereto, a system comprising:
a discovery agent that detects when the device is initially coupled or re-coupled to the network;
a provisioning agent coupled to the discovery agent that uses a device description document, including use of at least some of any device-independent information in the device description document, to provide a provisioning description document to the device when the device is not already provisioned or is being re-provisioned, the device configurable for interaction with at least one other entity on the network by the provisioning document; and
a network entity that interacts with the device once the device is configured according to the provisioning description document.

11. The system of claim 10 wherein the network entity comprises a server and wherein the discovery agent is incorporated into the server.

12. The system of claim 10 wherein the device comprises a communication terminal and wherein the network entity comprises a server that facilitates connections between one or more communication terminals.

13. The system of claim 10 wherein the network device is coupled to the discovery agent via a wired or wireless local area network connection, or the network device is coupled to the discovery agent via a wired or wireless Internet connection.

14. The system of claim 10 wherein the provisioning agent is coupled to the discovery agent coupled by a pool into which data corresponding to the device is logged by the discovery agent for consumption by the provisioning agent.

15. The system of claim 10 wherein the device description document and provisioning description document are each structured documents that each include a URI reference.

16. The system of claim 10 wherein the device description document includes data corresponding to physical device configuration, device maintenance or device management, or any combination of physical device configuration, device maintenance or device management.

17. The system of claim 10 further comprising a data store containing information corresponding to already provisioned devices, and wherein the discovery agent accesses the data store to determine whether the device is initially coupled to the network or is an already-provisioned device that is re-coupled to the network.

18. The system of claim 10 wherein the device includes a configuration mechanism that configures at least some device settings based on the provisioning description document, and a recovery mechanism that broadcasts a discovery message following a state change to the device with respect to the network.

19. A computer-readable medium having computer-executable instructions, which when executed perform steps, comprising, detecting a device coupled to a network, determining whether the device needs to be provisioned or needs to be re-provisioned on the network, and if so, communicating with a network server that is configured to interact with the device, and if not, providing data to a provisioning agent to provision the device for interaction with the network, the data corresponding to a device description document, including at least some of any device-independent information in the device description document.

20. The computer-readable medium of claim 19 wherein determining whether the device needs to be provisioned or needs to be re-provisioned on the network comprises accessing a data store, and when the data store indicates the device needs to be provisioned or needs to be re-provisioned, wherein providing the data to the provisioning agent comprises provided the device description document to the provisioning agent, or providing a reference to the device description document to the provisioning agent.
